(19) United States
(12) Patent Application Publication
(10) Pub. No.: US 2012/0165447 A1
(43) Pub. Date: Jun. 28, 2012

(54) Novel long-lasting bio-based plastics, the use thereof and a process for the production thereof

(75) Inventors: Andrea Fruth, Wiesbaden (DE); Ana Maria Cano Sierra, Heidelberg (DE); Andreas Krug, Mannheim (DE); Christian Steiger, Sandhausen (DE)

(73) Assignee: Rhein Chemie Rheinau GmbH, Mannheim (DE)

(21) Appl. No.: 13/196,937

(22) Filed: Aug. 3, 2011

(30) Foreign Application Priority Data
Aug. 11, 2010 (EP) 10172531.5

(51) Int. Cl. C08K 5/29

(52) U.S. Cl. 524/195

(57) ABSTRACT

The present invention relates to novel long-lasting and hydrolysis-resistant bio-based plastics based on polyester resins, the use thereof and the process for the production thereof.

The present invention relates to novel long-lasting and hydrolysis-resistant bio-based plastics based on polyester resins, the use thereof and the process for the production thereof.

Bio-based plastics, known as biopolymers, use bio-based raw materials and are therefore more environmentally sustainable than plastics based on petrochemicals. Particularly with a view to conservation of the environment and the threat of global warming, bio-based plastics have achieved increasing importance not only in the packaging sector but also in the production of long-lasting, and also technical plastics products. However, if bio-based materials are to become competitive with conventional and established materials, many improvements in the production and processing of the materials are still required.

Bio-based plastics are composed for example of aliphatic polyester resin, which is produced via polymerisation of monomers made of the following materials: starch, sugar, carbohydrates, fats or vegetable oil. Other bio-based plastics involve aliphatic-aromatic polyesters which are based on a biogenic diol component, or else involve biopolyamides, in which the acid component is obtained from naturally occurring substances.

Bio-based plastics have the great advantage of being environmentally compatible. However, they have the disadvantage of being highly susceptible to hydrolysis.

Attempts have been made to solve this problem by adding a very wide variety of additives, for example, EP-A 0 890 604 and EP-A 1 277 792 use carbodiimide compounds for stabilising biodegradable plastics compositions. The carbodiimides described in those documents involve aliphatic and aromatic monomeric and oligomeric carbodiimides, but these give only a small increase in lifetime.

Although the antioxidants used as additives in EP-A 1354917 reduce yellowing, they do not increase stability. The same applies to EP-A 1 876 205, which uses a biopolymer composition made of a biodegradable polyester with a carbodiimide, a phosphite compound and a silicate compound.

EP-A 1627894 discloses the production of a foil made of aliphatic polyester resins, preferably polylactic acid, where a wide variety of carbodiimides is mentioned for stabilisation. However, the criterion of long-term stability is achieved here only to a limited extent.

It is moreover known that up to 1% of a combination of Stabaxol® I and Carbodilite® LA-1 can be used in a ratio of from 1:1 to 1:2, see Abstract of US 2010/197842 and US 20090318628 A1. Here again, the result achieved in relation to hydrolysis resistance and processability is not satisfactory.

It was therefore an object to provide novel long-lived bio-based plastics which do not have the disadvantages of the prior art and have high hydrolysis resistance, good processability and a low level of yellowing.

Surprisingly, it has now been found that the bio-based plastics according to the invention, comprising a combination of at least one polyester resin and of at least one defined mixture of at least one aromatic monomeric carbodiimide and of at least one aromatic oligomeric and/or aromatic polymeric carbodiimide achieve the said object.

The present invention therefore provides bio-based plastics comprising a combination of at least one polyester resin and, based on the bio-based plastic, of a mixture of at least one aromatic monomeric carbodiimide and of at least one aromatic oligomeric and/or aromatic polymeric carbodiimide, where the ratio of aromatic monomeric to aromatic polymeric and/or aromatic oligomeric carbodiimide is >1:1. It is preferable here that the proportion of the said mixture of carbodiimides is at least 1% by weight, preferably more than 1.1% by weight, very particularly preferably ≧1.2%, based on the bio-based plastic.

For the purposes of the invention, the bio-based plastics preferably involve aliphatic polyester resins, where these have been produced by polymerisation of monomers made via fermentation of the following materials: starch, sugar, carbohydrates, fats or vegetable oil, or involve aliphatic-aromatic polyester resins based on a biogenic diol component, or else involve biopolyamides, in which the acid component is obtained from naturally occurring substances. Blends with bio-based plastics are also concomitantly encompassed here, e.g. polylactic acid (PLA) with polycarbonate or polybutylene terephthalate (PBT).

The polyesters for producing the bio-based plastics are commercially available, but can also be produced by the processes familiar to the person skilled in the art, e.g. by way of ring-opening polymerisation of lactides.

The bio-based plastics preferably involve polymers from the group of the aliphatic polyester resins. The group of the aliphatic polyester resins includes especially polylactic acid (PLA). It is equally possible to use aliphatic-aromatic polyester resins, e.g. polytrimethylene terephthalate (PTT), polybutylene terephthalate (PBT), polybutylene adipate terephthalate (PBAT) and/or polybutylene succinate terephthalate (PBST).

For the purposes of the invention, the polyester resins preferably involve aliphatic polyester resins which are produced by polymerisation of monomers made via fermentation of the following materials: starch, sugar, carbohydrates, fats or vegetable oil.

The polylactic acid particularly preferred as aliphatic polyester resin is commercially available, e.g. from NatureWorks, or can be produced by the processes familiar to the person skilled in the art, e.g. via ring-opening polymerisation of lactides. Production of polylactic acid via ring-opening polymerisation of lactides here is not restricted to any of the two enantiomers, L-lactic acid or D-lactic acid, or a mixture thereof. Also, other methods for producing polylactic acid are not excluded here. For the purposes of the invention, it is possible here to use the polymers of L-lactic acid and/or D-lactic acid as aliphatic polyester resin.

It is equally possible to use aliphatic-aromatic polyester resins, e.g. polytrimethylene terephthalate (PTT), polybutylene terephthalate (PBT), polybutylene adipate terephthalate (PBAT) and/or polybutylene succinate terephthalate (PBST).

Aromatic monomeric, aromatic oligomeric and/or aromatic polymeric carbodiimides used can comprise any of the known carbodiimides.

In one preferred embodiment of the present invention, at least one of the carbodiimides used is a sterically hindered carbodiimide.

The aromatic monomeric carbodiimide preferably involves a compound of the formula (I)

R′—N═C═N—R″ (I),

in which
R′ and R″ are identical or different and are aryl or C₇-C₁₈-aralkyl,
in the case of an aromatic moiety, R′ and R″ can, in at least one ortho-position with respect to the aromatic carbon atom which bears the carbodiimide group, bear aliphatic and/or cycloaliphatic and/or aromatic substituents having at least one carbon atom, where these can also bear heteroatoms, e.g. O, N and/or S.

It is particularly preferable that the aromatic monomeric carbodiimide involves a sterically hindered, aromatic carbodiimide of the general formula (II),

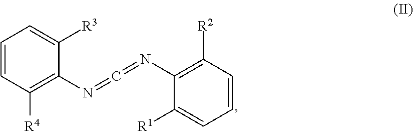

in which
R¹ to R⁴ are mutually independently H, C₁-C₂₀-alkyl, preferably branched C₃-C₂₀-alkyl, C₃-C₂₀-cycloalkyl, C₆-C₁₅-aryl or a C₆-C₁₅-aralkyl moiety, where this can optionally also comprise heteroatoms, e.g. O, N and/or S.

It is moreover preferable that the moieties R¹ to R⁴ involve hydrogen and/or diisopropyl moieties.

The aromatic polymeric or oligomeric carbodiimides preferably involve compounds of the general formula (III)

R⁵—(—N═C═N—R′″—)ₘ—R⁶ (III)

in which
R′″ is an aromatic and/or araliphatic moiety,
R′″ within the molecule is identical or different and in various combinations each of the abovementioned moieties can be combined as desired with one another,
R′″ can, in at least one ortho-position with respect to the aromatic carbon atom which bears the carbodiimide group, bear aliphatic and/or cycloaliphatic and/or aromatic substituents having at least one carbon atom, where these can also bear heteroatoms, or R′″ can bear no such substituents,
R⁵=C₁-C₁₈-alkyl, C₅-C₁₈-cycloalkyl, aryl, C₇-C₁₈-aralkyl, —R′″—NH—COS—R⁷, —R′″—COOR⁷, —R′″—OR⁷, —R′″—N(R⁷)₂, —R′″—SR⁷, —R′″—OH, R′″—NH₂, —R′″—NHR⁷, R′″-epoxy, —R′″—NCO, —R′″—NHCONHR⁷, —R′″—NHCONR⁷R⁸ or —R′″—NHCOOR⁹ and
R⁶=—N═C═N-aryl, —N═C═N-alkyl, —N═C═N-cycloalkyl, —N═C═N-aralkyl, —NCO, —NHCONHR⁷, —NHCONHR⁷R⁸, —NHCOOR⁹, —NHCOS—R⁷, —COOR⁷, —N(R⁷)₂, —SR⁷, -epoxy, —OH, —NH₂, —NHR⁷,
   where, in R⁵ and R⁶, mutually independently, R⁷ and R⁸ are identical or different and are a C₁-C₂₀-alkyl moiety, C₃-C₂₀-cycloalkyl moiety, C₇-C₁₈-aralkyl moiety, oligo/polyethylene glycols and/or oligo/polypropylene glycols, and R⁹ complies with one of the definitions of R⁷ or is a polyester moiety or a polyamide moiety, and where
   in the case of oligomeric aromatic carbodiimides m is an integer from 1 to 5, and
   in the case of polymeric aromatic carbodiimides m is an integer >5, preferably from 6 to 50.

It is particularly preferable that R⁵=diisopropylphenyl and/or diisopropylphenyl isocyanate and/or —R′″—NHCOOR⁷ and/or cyclohexyl. Particularly preferred meanings of R⁶ are —NCO and/or —N═C═N-diisopropylphenyl and/or —N═C═N-cyclohexyl and/or —NHCOOR⁷.

However, it is also possible that the aromatic polymeric or oligomeric carbodiimide can involve compounds of the formula (III) in which R′″=1,3-substituted-2,4,6-triisopropylphenyl and/or a tetramethylxylylene derivative and/or 2,4-substituted tolylene, 2,6-substituted tolylene and/or a mixture of 2,4- or 2,6-substituted tolylene.

In another embodiment of the present invention it is also possible to use a mixture of various polymeric, and/or a mixture of oligomeric and polymeric, carbodiimides.

The abovementioned aromatic monomeric carbodiimides, and also the aromatic oligomeric/polymeric carbodiimides, the compounds of the formulae (II) and (III), involve commercially available compounds which are obtainable by way of example from Rhein Chemie Rheinau GmbH.

It is equally possible to produce the carbodiimides by the processes described by way of example in Angewandte Chemie 74 (21), 1962, pp. 801-806 or via condensation of diisocyanates with elimination of carbon dioxide at elevated temperatures, e.g. at from 40° C. to 200° C., in the presence of catalysts. Suitable processes are described in DE-A-11 30 594 and in DE-B-11 56 401. Examples of catalysts that have proved successful are strong bases or phosphorus compounds. Preference is given to phospholene oxides, phospholidines or phospholine oxides, and also to the corresponding sulphides. Other catalysts that can be used are tertiary amines, basic metal compounds, metal carboxylates and non-basic organometallic compounds.

Suitable compounds for producing the carbodiimides and/or polycarbodiimides used are any of the isocyanates, and for the purposes of the present invention here it is preferable to use carbodiimides and/or polycarbodiimides which are based on C₁-C₄-alkyl-substituted aromatic isocyanates, e.g. 2,6-diisopropylphenyl isocyanate, 2,4,6-triisopropylphenyl 1,3-diisocyanate, 2,4,6-triethylphenyl 1,3-diisocyanate, 2,4,6-trimethylphenyl 1,3-diisocyanate, 2,4′-diisocyanatodiphenylmethane, 3,3′,5,5′-tetraisopropyl-4,4′-diisocyanatodiphenylmethane, 3,3′,5,5′-tetraethyl-4,4′-diisocyanato-diphenylmethane, tetramethylxylene diisocyanate, naphthalene 1,5-diisocyanate, diphenylmethane 4,4′-diisocyanate, diphenyldimethylmethane 4,4′-diisocyanate, phenylene 1,3diisocyanate, phenylene 1,4-diisocyanate, tolylene 2,4-diisocyanate, tolylene 2,6-diisocyanate, a mixture of tolylene 2,4-diisocyanate and tolylene 2,6-diisocyanate, hexamethylene diisocyanate, cyclohexane 1,4-diisocyanate, xylylene diisocyanate, isophorone diisocyanate, dicyclohexylmethane 4,4′-diisocyanate, methylcyclohexane diisocyanate, tetramethylxylylene diisocyanate, 2,6-diisopropylphenylene isocyanate and 1,3,5-triisopropylbenzene 2,4-diisocyanate or a mixture of these, or which are based on substituted aralkylene, e.g. 1,3-bis(1-methyl-1-isocyanatoethyl)benzene. It is particularly preferable that the carbodiimides and/or polycarbodiimides are based on 2,4,6-triisopropylphenyl 1,3-diisocyanate and/or on 2,6-diisopropylphenyl)ene isocyanate and/or on tetramethylxylylene diisocyanate and/or on tolylene 2,4-diisocynate and/or on tolylene 2,6-diisocyanate and/or on a mixture of tolylene 2,4- and 2,6-diisocyanate.

It is preferable that the proportion of sterically hindered carbodiimide and the oligomeric/polymeric carbodiimide in the polyester resin is from 1 to 5%.

It is moreover preferable that the proportion of polyester resin in the bio-based plastic is from 5 to 99.5%, particularly from 50 to 99.0%.

In another preferred embodiment of the invention, the ratio of aromatic monomeric carbodiimide to the aromatic oligomeric and/or aromatic polymeric carbodiimide is >1.5:1.

The present invention also provides a process for producing the bio-based plastics, where at least one polyester resin is mixed with at least one aromatic monomeric carbodiimide and with at least one aromatic oligomeric carbodiimide and/or aromatic polymeric carbodiimide in a mixing assembly, where the ratio of aromatic monomeric to aromatic polymeric and/or aromatic oligomeric carbodiimide is >1:1.

The sequence in which the various carbodiimides are incorporated by mixing here can be freely selected. It is also possible to add the carbodiimides after production of the bio-based plastic.

An example of mixing assemblies for the purposes of the invention is an extruder or kneader.

The invention also provides a process for the production of bio-based plastics for long-lasting applications, e.g. electronics, automotive systems, in the transport industry (land, water and air), in construction, in the domestic sector, e.g. in the form of bath utensils, or in the form of office requisite, or for applications under “severe conditions”, e.g. sterile conditions in medicine by adding a mixture of at least one polyester resin with at least one aromatic monomeric carbodiimide and with at least one aromatic oligomeric carbodiimide and/or aromatic polymeric carbodiimide, where the ratio of aromatic monomeric to aromatic polymeric and/or aromatic oligomeric carbodiimide is >1:1 or by forming the bio-based plastics out of a mixture of at least one polyester resin with at least one aromatic monomeric carbodiimide and with at least one aromatic oligomeric carbodiimide and/or aromatic polymeric carbodiimide, where the ratio of aromatic monomeric to aromatic polymeric and/or aromatic oligomeric carbodiimide is >1:1

The invention also provides the use of the bio-based plastics according to the invention in long-lasting applications, e.g. electronics, automotive systems, in the transport industry (land, water and air), in construction, in the domestic sector, e.g. in the form of bath utensils, or in the form of office requisite, or for applications under “severe conditions”, e.g. sterile conditions in medicine.

The examples below serve to illustrate the invention, without any resultant limiting effect.

### INVENTIVE EXAMPLE

### Chemicals Used

CDI I: a sterically hindered aromatic monomeric carbodiimide (Stabaxol® I) having at least 10.0% NCN content from Rhein Chemie Rheinau GmbH.

CDI II, a sterically hindered aromatic polymeric carbodiimide (Stabaxol® P) having 13.5% NCN content from Rhein Chemie Rheinau GmbH.

Carbodilite® LA-1 (H12MDI-PCDI): a polymeric aliphatic carbodiimide having 15.8% NCN content, from Nisshinbo Chemical Inc.

Polylactic acid (PLA) from NatureWorks 2002 D.

### Equipment Used

A ZSK 25 laboratory twin-screw extruder from Werner & Pfleiderer was used to incorporate the carbodiimides into the polylactic acid.

The amounts of carbodiimide used and the nature of the carbodiimide used are found in Table 1.

The F3 standard test specimens were produced in an Arburg Allrounder 320 S 150-500 injection-moulding machine.

For the polylactic acid (PLA) hydrolysis test, the F3 standard test specimens were stored in water at a temperature of 65° C. and a tensile test was carried out after various periods in order to monitor tensile strength. The hydrolysis resistance time here describes the lifetime of the test specimens in days before the tensile strength assumed a value of less than 5 MPa under test conditions.

The LAB yellowness index was measured on granulated polymer materials in Match Rite colour measurement equipment from X-Rite.

Number-average molar masses Mₙ were determined by gel permeation chromatography. Tetrahydrofuran was used as eluent. The detector used comprised a MP 250 dual detector from Viscotec. The stationary phase used comprised the following three types of column in series: 1×PSS Gel SDV 10⁵ Å, 1×PL Gel 10⁴ Å, 1×PL Gel SDV 500 Å. Column temperature and detector temperature was 40° C. The pump used comprised a TSP 100 from Thermo Fisher. The specimens were injected by way of an AS 100 autosampler from Thermo Fisher.

TABLE 1
Specimens according to the invention and test results for these:

| | | | | LAB |
|---|---|---|---|---|
| | | Hydrolysis | | yellow- |
| | | resistance time | Mₙ | ness index |
| Specimen | Additives used | [d] | [g/mol] | (B) |
| 1 | 1.0% CDI I + | 35 | 49 780 | 8.0 |
| | 0.5% CDI II | | | |

TABLE 2
Comparative examples:

| | | | | LAB |
|---|---|---|---|---|
| | | Hydrolysis | | yellow- |
| | | resistance time | Mₙ | ness index |
| Specimen | Additives used | [d] | [g/mol] | (B) |
| 2 | 0.5% CDI I + | 21 | 45 400 | 7.6 |
| | 1.0% CDI II | | | |
| 3 | 0.5% CDI I + | 13 | 46 800 | 6.8 |
| | 0.5% CDI II | | | |
| 4 | PLA 1 x extruded | 5 | 39 400 | 7.2 |
| | (reference | | | |
| | specimen) | | | |
| 5 | 1.5% CDI II | 11 | 59 510 | 9.3 |
| 6 | 1.5% H12MDI-PCDI | 18 | 48 400 | 11.3 |
| 7 | 0.5% CDI I + | 29 | 46 300 | 10.5 |
| | 0.5% H12MDI-PCDI | | | |
| 8 | 1.0% CDI I + | 38 | 44 850 | 10.1 |
| | 0.5% H12MDI-PCDI | | | |

Important factors for the intended applications are good values not only in respect of hydrolysis resistance but also in respect of processability in conjunction with a low level of yellowing.

All of the specimens according to the invention are hydrolysis-resistant (at least 21 days up to 35 days) and have good processability due to high molecular weight, and have a low level of yellowing at ≦8.

In the case of the comparative examples, the specimens always have only one improved property, and there is never a simultaneous improvement in all three properties.

What is claimed is:

1. Bio-based plastics comprising a combination of at least one polyester resin and, based on the bio-based plastic, of a mixture of at least one aromatic monomeric carbodiimide and of at least one aromatic oligomeric and/or aromatic polymeric carbodiimide, where the ratio of aromatic monomeric to aromatic polymeric and/or aromatic oligomeric carbodiimide is >1:1.

2. Bio-based plastics according to claim 1, characterized in that at least one of the carbodiimides is a sterically hindered carbodiimide.

3. Bio-based plastics according to claim 1 or 2, characterized in that the proportion of the carbodiimides is at least 1% by weight.

4. Bio-based plastics according to one or more of claims 1 to 4, characterized in that the aromatic monomeric carbodiimide involves a compound of the formula (I)
R′—N═C═N—R″ (I)
in which
R′ and R″ are identical or different and are aryl or C₇-C₁₈-aralkyl,
in the case of an aromatic moiety, R′ and R″ can, in at least one ortho-position with respect to the aromatic carbon atom which bears the carbodiimide group, bear aliphatic and/or cycloaliphatic and/or aromatic substituents having at least one carbon atom, where these can also bear heteroatoms, or R′ and R″ can bear no such substituents.

5. Bio-based plastics according to claim 4, characterized in that the aromatic monomeric carbodiimide involves a sterically hindered, aromatic carbodiimide of the general formula (II) 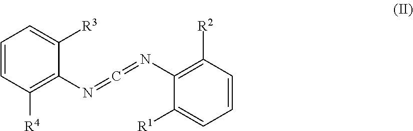
in which
R¹ to R⁴ are mutually independently H, C₁-C₂₀-alkyl, C₃-C₂₀-cycloalkyl, C₆-C₁₅-aryl or a C₆-C₁₅-aralkyl moiety, where this can optionally also comprise heteroatoms.

6. Bio-based plastics according to one or more of claims 1 to 5, characterized in that the aromatic polymeric or oligomeric carbodiimide involves compounds of the general formula (III)
R⁵—(—N═C═N—R′″—)ₘ—R⁶ (III)
in which
R′″ is an aromatic and/or araliphatic moiety,
R′″ within the molecule is identical or different and in various combinations each of the abovementioned moieties can be combined as desired with one another,
R′″ can, in at least one ortho-position with respect to the aromatic carbon atom which bears the carbodiimide group, bear aliphatic and/or cycloaliphatic and/or aromatic substituents having at least one carbon atom, where these can also bear heteroatoms, or R′″ can bear no such substituents,
R⁵=C₁-C₁₈-alkyl, C₅-C₁₈-cycloalkyl, aryl, C₇-C₁₈-aralkyl, —R′″—NH—COS—R⁷, —R′″—COOR⁷, —R′″—OR⁷, —R′″—N(R⁷)₂, —R′″—SR⁷, —R′″—OH, R′″—NH₂, —R′″—NHR⁷, R′″-epoxy, —R′″—NCO, —R′″—NHCONHR⁷, —R′″—NHCONR⁷R⁸ or —R″—NHCOOR⁹ and
R⁶=—N═C═N-aryl, —N═C═N-alkyl, —N═C═N-cycloalkyl, —N═C═N-aralkyl, —NCO, —NHCONHR⁷, —NHCONHR⁷R⁸, —NHCOOR⁹, —NHCOS—R⁷, —COOR⁷, —OR⁷, -epoxy, —N(R⁷)₂, —SR⁷, —OH, —NH₂, —NHR⁷,
where, in R⁵ and R⁶, mutually independently, R⁷ and R⁸ are identical or different and are a C₁-C₂₀-alkyl moiety, C₃-C₂₀-cycloalkyl moiety, C₇-C₁₈-aralkyl moiety, oligo/polyethylene glycols and/or oligo/polypropylene glycols, and R⁹ complies with one of the definitions of R⁷ or is a polyester moiety or a polyamide moiety, and in the case of oligomeric aromatic carbodiimides m is an integer from 1 to 5, and in the case of polymeric aromatic carbodiimides m is an integer >5.

7. Bio-based plastics according to one or more of claims 1 to 6, characterized in that the aromatic polymeric or oligomeric carbodiimide involves compounds of the formula (III) where R′″ is a 1,3-substituted 2,4,6-triisopropylphenyl and/or a tetramethylxylylene derivative and/or 2,4-substituted tolylene and/or 2,6-substituted tolylene and/or a mixture of 2,4- or 2,6-substituted tolylene.

8. Bio-based plastics according to one or more of claims 1 to 7, characterized in that the polyester resin involves polylactic acid, polytrimethylene terephthalate (PTT), polybutylene terephthalate (PBT), polybutylene adipate terephthalate (PBAT) and/or polybutylene succinate terephthalate (PBST).

9. Process for producing the bio-based plastics according to one or more of claims 1 to 8, characterized in that at least one polyester resin is mixed with at least one aromatic monomeric carbodiimide and with at least one aromatic oligomeric and/or aromatic polymeric carbodiimide in a mixing assembly, where the ratio of aromatic monomeric to aromatic polymeric and/or aromatic oligomeric carbodiimide is >1:1.

10. Process for the production of bio-based plastics for electronics, automotive systems, in the transport industry, in construction, in the domestic sector, in the form of office requisite, or for applications under “severe conditions”, by using a bio-based plastics according to one or more of claims 1 to 8
